(19) United States
(12) Patent Application Publication
(10) Pub. No.: US 2026/0259383 A1
(43) Pub. Date: Sep. 3, 2026

(54) VARIABLE COUPLER

(71) Applicant: TAARA CONNECT, INC., Sunnyvale, CA (US)

(72) Inventors: Joaquin Matres Abril, Palo Alto, CA (US); Stephen Palese, Menlo Park, CA (US); Ondrej Cierny, San Francisco, CA (US); Tymon Barwicz, Holmdel, NJ (US); Devin Brinkley, Redwood City, CA (US); Paul Epp, Sunnyvale, CA (US)

(21) Appl. No.: 19/535,234

(22) Filed: Feb. 10, 2026

Related U.S. Application Data
(60) Provisional application No. 63/766,099, filed on Mar. 3, 2025.

(51) Int. Cl. G02B 6/43; G02B 6/42; H04B 10/079; H04B 10/40

(52) U.S. Cl. CPC G02B 6/43; G02B 6/4295; H04B 10/079; H04B 10/40; H04B 2210/003

(57) ABSTRACT

Aspects of the technology provide an optical communications terminal. The optical communications terminal including one or more variable couplers configured to variably split signals based on a splitting ratio; and a control system operatively connected to the one or more variable couplers, the control system configured to drive the one or more variable couplers to variably split signals based on the splitting ratio, wherein the control system is configured to drive the one or more variable couplers based on one of i) measurements regarding a dither injected into a signal, or 2) measurements from one or more photodetectors operatively coupled to the one or more variable couplers.

### A CROSS REFERENCE TO RELATED APPLICATIONS

The present application claims the benefit of the filing date of U.S. Provisional Application No. 63/766,099, filed Mar. 3, 2025, the entire disclosure of which is incorporated by reference herein.

### BACKGROUND

Wireless optical communication enables high-throughput and long-range communication, in part due to high gain offered by the narrow angular width of the transmitted beam. However, the narrow beam also requires that it must be accurately and actively pointed in order to remain aligned to an aperture of a communications terminal at the remote end. This pointing may be accomplished by small mirrors (e.g., microelectromechanical systems or voice-coil based fast-steering mirror mechanisms) that are actuated to steer the beam. In other implementations, electrically controllable steering of beams with no moving parts is used to steer the beam, which provides cost, lifetime and performance advantages. Optical Phased Arrays (OPAs) are a critical technology component, with added benefits of adaptive-optics, point-to-multipoint support, and mesh network topologies. Each active element in the OPA requires electrically controllable shifting capability.

### BRIEF SUMMARY

Aspects of the disclosure provide an optical communications terminal. The optical communications terminal, comprising one or more variable couplers configured to variably split signals based on a splitting ratio; and a control system operatively connected to the one or more variable couplers, the control system configured to drive the one or more variable couplers to variably split signals based on the splitting ratio, wherein the control system is configured to drive the one or more variable couplers based on one of i) measurements regarding a dither injected into a signal, or 2) measurements from one or more photodetectors operatively coupled to the one or more variable couplers.

In one example, the optical communications terminal further includes the one or more photodetectors operatively connected to an output of the one or more variable couplers. Additionally, the control system may be operatively connected to the one or more photodetectors; and the control system may be configured to receive measurements from the one or more photodetectors.

In a further example, the splitting ratio is 50%/50%. In another example, the splitting ratio is 0%/100%. In an additional example the splitting ratio is 100%/0%.

In another example, in a receive direction, the one or more variable couplers include a first input and a second input. Additionally, the first input and the second input may be respectively connected to a first emitter and a second emitter. Alternatively, the one or more variable couplers may include a first variable coupler, a second variable coupler, and a third variable coupler; the first input may be a first input of the first variable coupler operatively connected to an output of the second variable coupler; and the second input may a second input of the first variable coupler operatively connected to an output of the third variable coupler.

In a further example, in a receive direction, the one or more variable couplers include a first output and a second output. Additionally, the first output may be connected to a photodetector of the one or more photodetectors. Alternatively, the one or more variable couplers may include a first variable coupler and a second variable coupler; and the second output may be connected to one of the second variable coupler or an edge coupler.

In another example, in a transmit direction, the one or more variable couplers include a first output and a second output. Additionally, the first output and the second output may be respectively connected to a first emitter and a second emitter. Alternatively, the one or more variable couplers may include a first variable coupler, a second variable coupler, and a third variable coupler; the first output may be a first output of the first variable coupler operatively connected to an input of the second variable coupler; and the second output may be a second output of the first variable coupler operatively connected to an input of the third variable coupler.

Another aspect of the disclosure is directed towards a method of variably splitting a signal in an optical communications terminal. The method comprising receiving, at one or more inputs of a variable coupler of the optical communications terminal, one or more portions of a signal; driving, by a control system of the optical communications terminal, the variable coupler to split the one or more portions of the signal based on a splitting ratio; outputting, by a first output of the variable coupler, a first portion of the signal based on the splitting ratio; and outputting, by a second output of the variable coupler, a second portion of the signal based on the splitting ratio.

In one example, the splitting ratio is one of 50%/50%; 0%/100%; or 100%/0%. In another example, the first output of the variable coupler is directed towards a photodetector of the one or more photodetectors. In a further example, the first output of the variable coupler is directed towards an emitter. In an additional example, the driving is based on one of i) measurements regarding a dither injected into a signal at a previous timestep, or 2) measurements from one or more photo detectors operatively coupled to the one or more variable couplers at a previous timestep.

### BRIEF DESCRIPTION OF THE DRAWINGS

FIG. 1 is a block diagram 100 of a first optical communications terminal and a second optical communications terminal in accordance with aspects of the disclosure.

FIG. 2 is a pictorial diagram 200 of an example system architecture for the first communication terminal of FIG. 1 in accordance with aspects of the disclosure.

FIG. 3 represents features of an OPA architecture represented as an example OPA chip in accordance with aspects of the disclosure.

FIG. 4 is a pictorial diagram of a network in accordance with aspects of the disclosure.

FIG. 5A illustrates an example system in accordance with aspects of the disclosure.

FIG. 5B illustrates an example variable coupler in accordance with aspects of the disclosure.

FIG. 6A illustrates an example system in accordance with aspects of the disclosure.

FIG. 6B illustrates an example variable coupler in accordance with aspects of the disclosure.

FIG. 7 is a flow diagram in accordance with aspects of the disclosure.

### DETAILED DESCRIPTION

### Overview

The technology relates to variable couplers configured to variably split signals (e.g., optical communications beams or signals) along transmit and receive paths within an optical communications terminal. The variable splitting may assist in the distribution of signals across pathways (e.g., waveguides, optical fibers) within the terminal. The variable coupler may allow for selective distributions that are advantageous when obstacles are present in the path of a signal. In this way, power received signals received at the optical communications terminal may be maximized and power transmitted to a remote optical communications terminal may be maximized.

The systems and methodology described herein may allow for variable splitting of signals throughout an optical communications terminal. The variable splitting may allow for maximizing received power even when obstacles are present in a signal path in free space outside the terminal. Similarly, the variable splitting may allow for focusing transmitting power where obstacles in free space are not present. In this regard, the variable splitting can be considered “active” variable splitting, enabling optimization of different transmit and receive beam profiles to improve link performance in real time.

### Example Systems

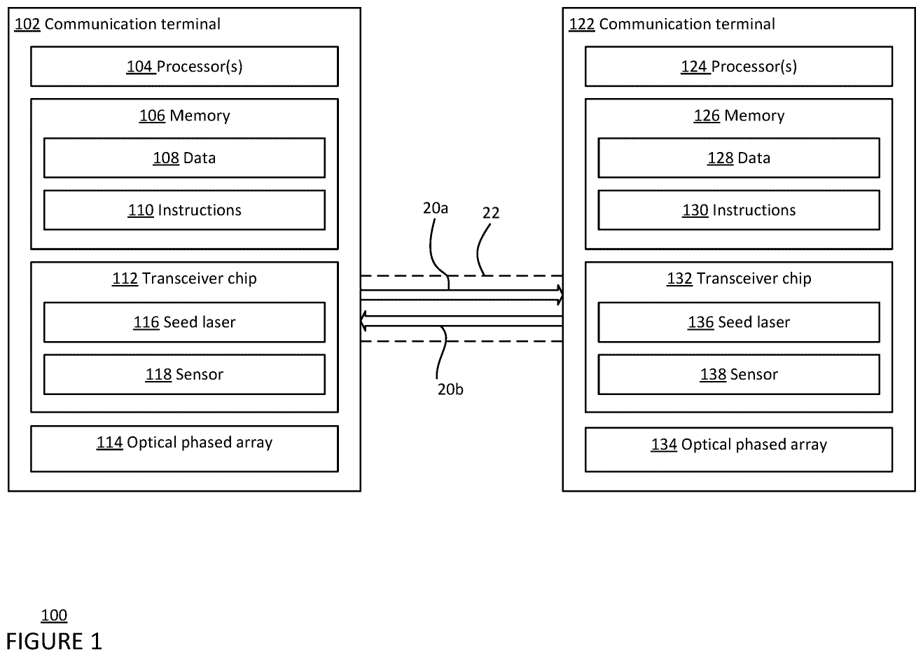

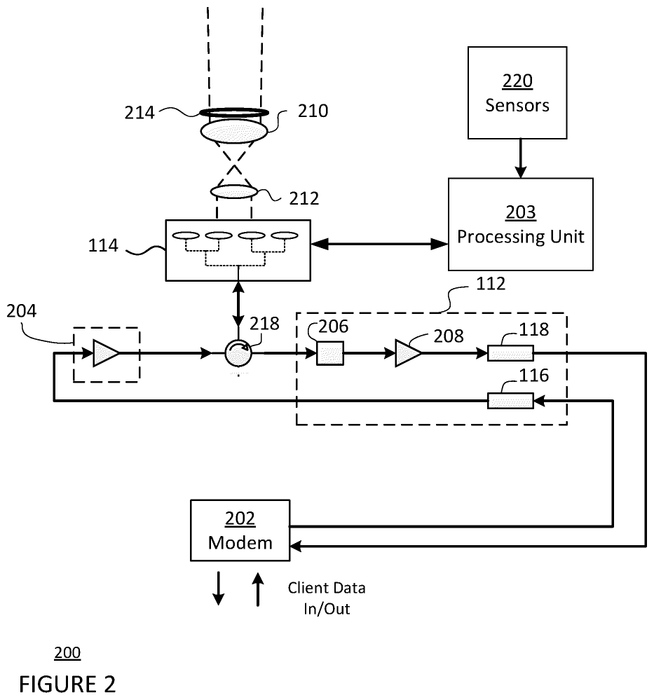

FIG. 1 is a block diagram 100 of a first optical communications terminal configured to form one or more links with a second optical communications terminal, for instance as part of a system such as a free-space optical communication (FSOC) system. FIG. 2 is a pictorial diagram 200 of an example communications terminal, such as the first optical communications terminal of FIG. 1. For example, a first optical communications terminal 102 includes one or more processors 104, a memory 106, a transceiver photonic integrated chip 112, and an optical phased array (OPA) architecture 114. In some implementations, the first optical communications terminal 102 may include more than one transceiver chip and/or more than one OPA architecture (e.g., more than one OPA chip).

The one or more processors 104 may be any conventional processors, such as commercially available CPUs. Alternatively, the one or more processors may be a dedicated device such as an application specific integrated circuit (ASIC) or another hardware-based processor, such as a field programmable gate array (FPGA). Although FIG. 1 functionally illustrates the one or more processors 104 and memory 106 as being within the same block, such as in a modem 202 for digital signal processing shown in FIG. 2, the one or more processors 104 and memory 106 may actually comprise multiple processors and memories that may or may not be stored within the same physical housing, such as in both the modem 202 and a separate processing unit 203. Accordingly, references to a processor or computer will be understood to include references to a collection of processors or computers or memories that may or may not operate in parallel.

Memory 106 may store information accessible by the one or more processors 104, including data 108, and instructions 110, that may be executed by the one or more processors 104. The memory may be of any type capable of storing information accessible by the processor, including a computer-readable medium such as a hard-drive, memory card, ROM, RAM, DVD or other optical disks, as well as other write-capable and read-only memories. The system and method may include different combinations of the foregoing, whereby different portions of the data 108 and instructions 110 are stored on different types of media. In the memory of each communications terminal, such as memory 106, calibration information, such as one or more offsets determined for tracking a signal, may be stored.

Data 108 may be retrieved, stored or modified by one or more processors 104 in accordance with the instructions 110. For instance, although the system and method are not limited by any particular data structure, the data 108 may be stored in computer registers, in a relational database as a table having a plurality of different fields and records, XML documents or flat files. The data 108 may also be formatted in any computer-readable format such as, but not limited to, binary values or Unicode. By further way of example only, image data may be stored as bitmaps including grids of pixels that are stored in accordance with formats that are compressed or uncompressed, lossless (e.g., BMP) or lossy (e.g., JPEG), and bitmap or vector-based (e.g., SVG), as well as computer instructions for drawing graphics. The data 108 may comprise any information sufficient to identify the relevant information, such as numbers, descriptive text, proprietary codes, references to data stored in other areas of the same memory or different memories (including other network locations) or information that is used by a function to calculate the relevant data.

The instructions 110 may be any set of instructions to be executed directly (such as machine code) or indirectly (such as scripts) by the one or more processors 104. For example, the instructions 110 may be stored as computer code on the computer-readable medium. In that regard, the terms “instructions” and “programs” may be used interchangeably herein. The instructions 110 may be stored in object code format for direct processing by the one or more processors 104, or in any other computer language including scripts or collections of independent source code modules that are interpreted on demand or compiled in advance. Functions, methods and routines of the instructions 110 are explained in more detail below.

The one or more processors 104 may be in communication with the transceiver chip 112. As shown in FIG. 2, the one or more processors in the modem 202 may be in communication with the transceiver chip 112, being configured to receive and process incoming optical signals and to transmit optical signals. The transceiver chip 112 may include one or more transmitter components and one or more receiver components. The one or more processors 104 may therefore be configured to transmit, via the transmitter components, data in a signal, and also may be configured to receive, via the receiver components, communications and data in a signal. The received signal may be processed by the one or more processors 104 to extract the communications and data.

The transmitter components may include at minimum a light source, such as seed laser 116. Other transmitter components may include an amplifier, such as a high-power semiconductor optical amplifier 204. In some implementations, the amplifier is on a separate photonics chip. The seed laser 116 may be a distributed feedback laser (DFB), a laser diode, a fiber laser, or a solid-state laser. The light output of the seed laser 116, or optical signal, may be controlled by a current, or electrical signal, applied directly to the seed laser, such as from a modulator that modulates a received electrical signal. Light transmitted from the seed laser 116 is received by the OPA architecture 114.

The receiver components may include at minimum a sensor 118, such as a photodiode. The sensor may convert a received signal (e.g., light or optical communications beam), into an electrical signal that can be processed by the one or more processors. Other receiver components may include an attenuator, such as a variable optical attenuator 206, an amplifier, such as a semiconductor optical amplifier 208, or a filter.

The one or more processors 104 may be in communication with the OPA architecture 114. The OPA architecture 114 may include a micro-lens array, an emitter associated with each micro-lens in the array, a plurality of phase shifters, and waveguides that connect the components in the OPA. The OPA architecture may be positioned on a single chip, an OPA chip. The waveguides progressively merge between a plurality of emitters and an edge coupler that connect to other transmitter and/or receiver components. In this regard, the waveguides may direct light between photodetectors or fiber outside of the OPA architecture, the phase shifters, the waveguide combiners, the emitters and any additional component within the OPA. In particular, the waveguide configuration may combine two waveguides at each stage, which means the number of waveguides is reduced by a factor of two at every successive stage closer to the edge coupler. The point of combination may be a node, and a combiner may be at each node. The combiner may be a 2×2 multimode interference (MMI) or directional coupler.

The OPA architecture 114 may receive light from the transmitter components and outputs the light as a coherent communications beam to be received by a remote communications terminal or client device, such as second optical communications terminal 122. The OPA architecture 114 may also receive light from free space, such as a communications beam from second optical communications terminal 122, and provides such received light to the receiver components. The OPA architecture may provide the necessary photonic processing to combine an incoming optical communications beam into a single-mode waveguide that directs the beam towards the transceiver chip 112. In some implementations, the OPA architecture may also generate and provide an angle of arrival estimate to the one or more processors 104, such as those in processing unit 203.

The first optical communications terminal 102 may include additional components to support functions of the communications terminal. For example, the first optical communications terminal may include one or more lenses and/or mirrors that form a telescope. The telescope may receive collimated light and output collimated light. The received collimated light may be directed in a receive direction. The receive direction may be a direction in which collimated light (e.g., optical communications beams or signals) propagates when received by the first optical communications terminal. Similarly, the output or transmitted collimated light may be directed in a transmit direction. The receive direction may be a direction in which collimated light (e.g., optical communications beams or signals) propagates when transmitted from the first optical communications terminal.

The telescope may include an objective portion, an eyepiece portion, and a relay portion. As shown in FIG. 2, the first optical communications terminal may include a telescope including an objective lens 210, an eyepiece lens 212, and an aperture 214 (or opening) through which light may enter and exit the communications terminal. For ease of representation and understanding, the aperture 214 is depicted as distinct from the objective lens 210, though the objective lens 210 may be positioned within the aperture. The first optical communications terminal may include a circulator or wavelength splitter, such as a single mode circulator 218, that routes incoming light and outgoing light while keeping them on at least partially separate paths. The first optical communications terminal may include one or more sensors 220 for detecting measurements of environmental features and/or system components.

The first optical communications terminal 102 may include one or more steering mechanisms, such as one or more bias means for controlling one or more phase shifters, which may be part of the OPA architecture 114, and/or an actuated/steering mirror (not shown), such as a fast/fine pointing mirror. In some examples, the actuated mirror may be a MEMS 2-axis mirror, 2-axis voice coil mirror, or a piezoelectric 2-axis mirror. The one or more processors 104, such as those in the processing unit 203, may be configured to receive and process signals from the one or more sensors 220, the transceiver chip 112, and/or the OPA architecture 114 and to control the one or more steering mechanisms to adjust a pointing direction and/or wavefront shape. The first optical communications terminal also includes optical fibers or waveguides connecting optical components, creating a path between the seed laser 116 and OPA architecture 114 and a path between the OPA architecture 114 and the sensor 118.

Returning to FIG. 1, the second optical communications terminal 122 may output the Tx signals as an optical communications beam 20b (e.g., light) pointed towards the first optical communications terminal 102, which receives the optical communications beam 20b (e.g., light) as corresponding Rx signals. In this regard, the second optical communications terminal 122 includes one or more processors, 124, a memory 126, a transceiver chip 132, and an OPA architecture 134. The one or more processors 124 may be similar to the one or more processors 104 described above.

Memory 126 may store information accessible by the one or more processors 124, including data 128 and instructions 130 that may be executed by processor 124. Memory 126, data 128, and instructions 130 may be configured similarly to memory 106, data 108, and instructions 110 described above. In addition, the transceiver chip 132 and the OPA architecture 134 of the second optical communications terminal 122 may be similar to the transceiver chip 112 and the OPA architecture 114. The transceiver chip 132 may include both transmitter components and receiver components. The transmitter components may include a light source, such as seed laser 136 configured similar to the seed laser 116. Other transmitter components may include an amplifier, such as a high-power semiconductor optical amplifier. The receiver components may include a sensor 138 configured similar to sensor 118. Other receiver components may include an attenuator, such as a variable optical attenuator, an amplifier, such as a semiconductor optical amplifier, or a filter. The OPA architecture 134 may include an OPA chip including a micro-lens array, a plurality of emitters, a plurality of phase shifters. Additional components for supporting functions of the second optical communications terminal 122 may be included similar to the additional components described above. The second optical communications terminal 122 may have a system architecture that is same or similar to the system architecture shown in FIG. 2.

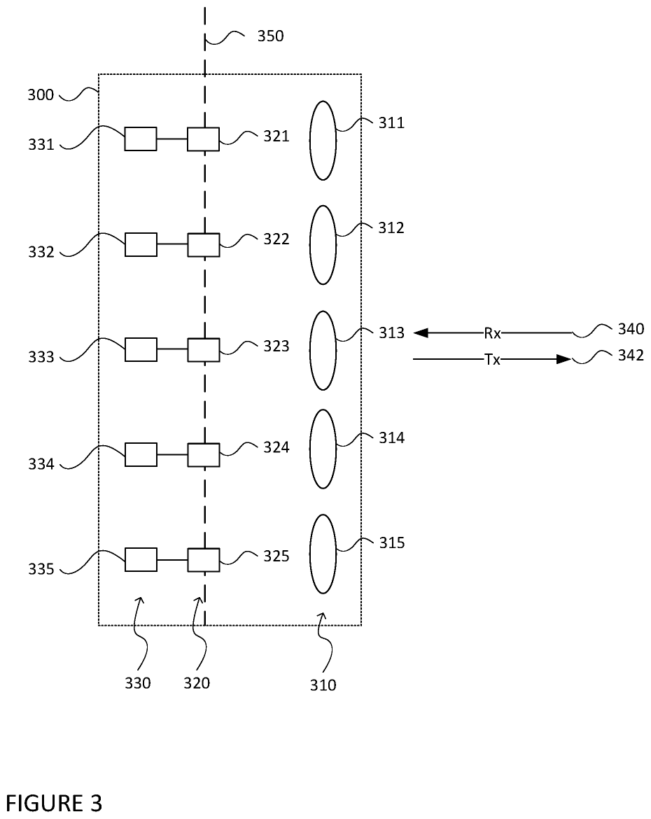

FIG. 3 represent features of OPA architecture 114 represented as an example OPA chip 300 including representations of a micro-lens array 310, a plurality of emitters 320, and a plurality of phase shifters 330. For clarity and ease of understanding, additional waveguides and other features are not depicted. Arrows 340, 342 respectively represent transmit and receive directions of transmitted signals (transmitted optical communications beam) from the optical communications terminal and received signals (received optical communications beam) from by the optical communications terminal as such signals pass or travel through the OPA chip 300.

The micro-lens array 310 may include a plurality of convex micro-lenses 311-315 that focus the Rx signals onto respective ones of the plurality emitters positioned at the focal points of the micro-lens array. In this regard, the dashed-line 350 represents the focal plane of the micro-lenses 311-315 of the micro-lens array 310. The micro-lens array 310 may be arranged in a grid pattern with a consistent pitch, or distance, between adjacent lenses. In other examples, the micro-lens array 310 may be in different arrangements having different numbers of rows and columns, different shapes, and/or different pitch (consistent or inconsistent) for different lenses.

Each micro-lens of the micro-lens array may be 10's to 1000's of micrometers in diameter and height. In addition, each micro-lens of the micro-lens array may be manufactured by molding, printing, or etching a lens directly into a wafer of the OPA chip 300. Alternatively, the micro-lens array 310 may be molded, printed, or etched as a separately fabricated micro-lens array. In this example, the micro-lens array 310 may be a rectangular or square plate of glass or silica a few mm (e.g., 10 mm or more or less) in length and width and 0.2 mm or more or less thick. Integrating the micro-lens array within the OPA chip 300 may allow for the reduction of the grating emitter size and an increase in the space between emitters. In this way, two-dimensional waveguide routing in the OPA architecture may better fit in a single layer optical phased array. In other instances, rather than a physical micro-lens array, the function of the micro-lens array may be replicated using an array of diffractive optical elements (DOE).

Each micro-lens of the micro-lens array may be associated with a respective emitter of the plurality of emitters 320. For example, each micro-lens may have an emitter from which Tx signals are received and to which the Rx signals are focused. As an example, micro-lens 311 is associated with emitter 321. Similarly, each micro-lens 312-315 also has a respective emitter 322-325. In this regard, for a given pitch (i.e., edge length of a micro-lens) the micro-lens focal length may be optimized for best transmit and receive coupling to the underlying emitters. This arrangement may thus increase the effective fill factor of the Rx signals at the respective emitter, while also expanding the Tx signals received at the micro-lenses from the respective emitter before the TX signals leave the OPA chip 300.

The plurality of emitters 320 may be configured to convert emissions from waveguides to free space and vice versa. The emitters may also generate a specific phase and intensity profile to further increase the effective fill factor of the Rx signals and improve the wavefront of the Tx signals. The phase and intensity profile may be determined using inverse design or other techniques in a manner that accounts for how transmitted signals will change as they propagate to and through the micro-lens array. The phase profile may be different from the flat profile of traditional grating emitters, and the intensity profile may be different from the gaussian intensity profile of traditional grating emitters. However, in some implementations, the emitters may be Gaussian field profile grating emitters.

The phase shifters 330 may allow for sensing and measuring Rx signals and the altering of Tx signals to improve signal strength optimally combining an input wavefront into a single waveguide or fiber. Each emitter may be associated with a phase shifter. As shown in FIG. 3, each emitter may be connected to a respective phase shifter. As an example, the emitter 320 is associated with a phase shifter 330. The Rx signals received at the phase shifters 331-335 may be provided to receiver components including the sensor 118, and the Tx signals from the phase shifters 331-335 may be provided to the respective emitters of the plurality of emitters 320. The architecture for the plurality of phase shifters 330 may include at least one layer of phase shifters having at least one phase shifter connected to an emitter of the plurality of emitters 320. In some examples, the phase shifter architecture may include a plurality of layers of phase shifters, where phase shifters in a first layer may be connected in series with one or more phase shifters in a second layer.

A communication link 22 may be formed between the first optical communications terminal 102 and the second optical communications terminal 122 when the transceivers of the first and second optical communications terminals are aligned. The alignment can be determined using the optical communications beams 20a, 20b to determine when line-of-sight is established between the communications terminals 102, 122. Using the communication link 22, the one or more processors 104 can send communication signals using the optical communications beam 20a to the second optical communications terminal 122 through free space, and the one or more processors 124 can send communication signals using the optical communications beam 20b to the first optical communications terminal 102 through free space. The communication link 22 between the first and second optical communications terminals 102, 122 allows for the bidirectional transmission of data between the two devices. In particular, the communication link 22 in these examples may be free-space optical communications (FSOC) links. In other implementations, one or more of the communication links 22 may be radio-frequency communication links or other type of communication link capable of traveling through free space.

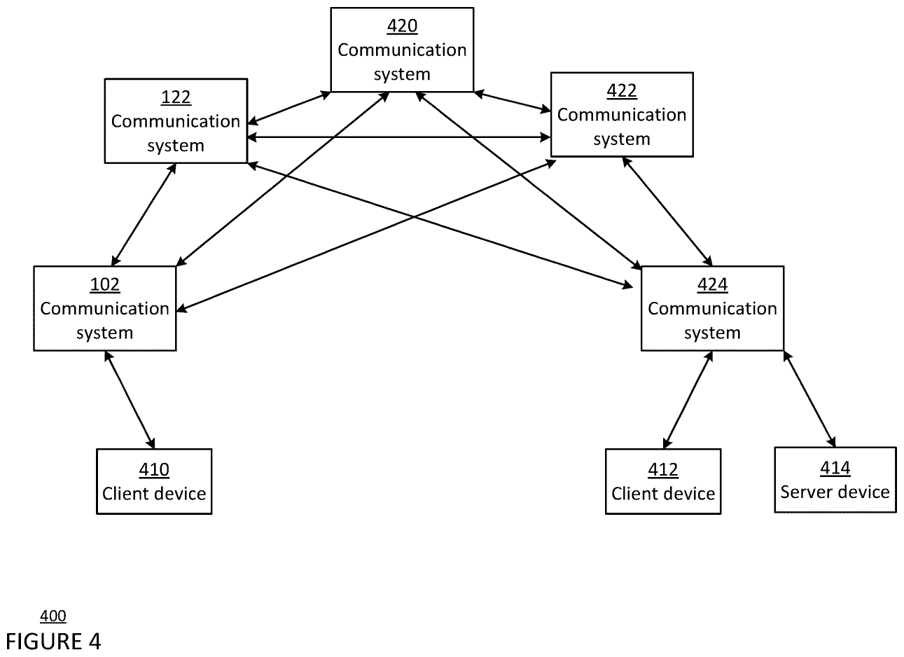

As shown in FIG. 4, a plurality of communications terminals, such as the first optical communications terminal 102 and the second optical communications terminal 122, may be configured to form a plurality of communication links (illustrated as arrows) between a plurality of communications terminals, thereby forming a network 400. The network 400 may include client devices 410 and 412, server device 414, and communications terminals 102, 122, 420, 422, and 424. Each of the client devices 410, 412, server device 414, and communications terminals 420, 422, and 424 may include one or more processors, a memory, a transceiver chip, and an OPA architecture (e.g., OPA chip or chips) similar to those described above. Using the transmitter and the receiver, each communications terminal in network 400 may form at least one communication link with another communications terminal, as shown by the arrows. The communication links may be for optical frequencies, radio frequencies, other frequencies, or a combination of different frequency bands. In FIG. 4, the first optical communications terminal 102 is shown having communication links with client device 410 and communications terminals 122, 420, and 422. The second optical communications terminal 122 is shown having communication links with communications terminals 102, 420, 422, and 424.

The network 400 as shown in FIG. 4 is illustrative only, and in some implementations the network 400 may include additional or different communications terminals. The network 400 may be a terrestrial network where the plurality of communications terminals is on a plurality of ground communications terminals. In other implementations, the network 400 may include one or more high-altitude platforms (HAPs), which may be balloons, blimps or other dirigibles, airplanes, unmanned aerial vehicles (UAVs), satellites, or any other form of high-altitude platform, or other types of moveable or stationary communications terminals. In some implementations, the network 400 may serve as an access network for client devices such as cellular phones, laptop computers, desktop computers, wearable devices, or tablet computers. The network 400 also may be connected to a larger network, such as the Internet, and may be configured to provide a client device with access to resources stored on or provided through the larger computer network.

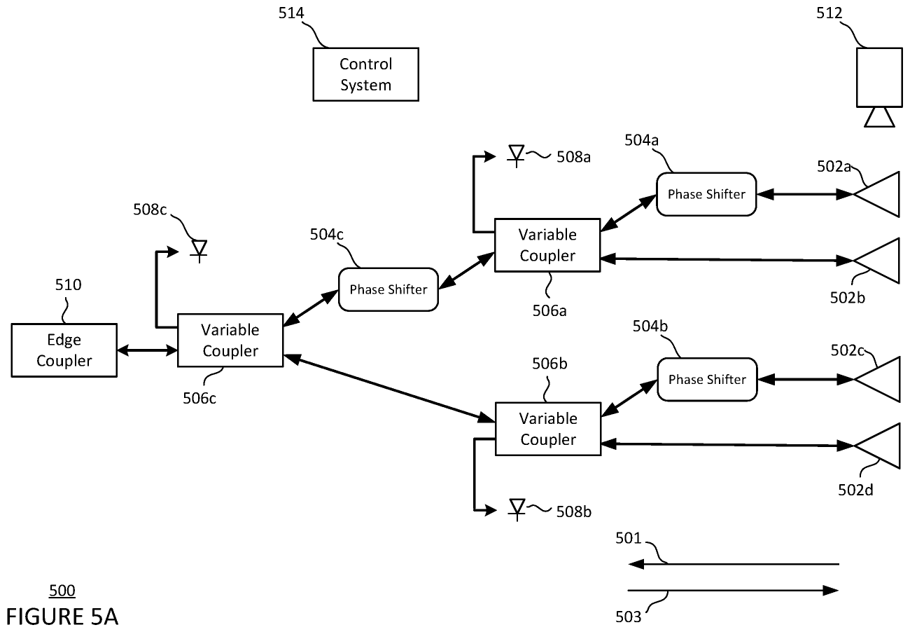

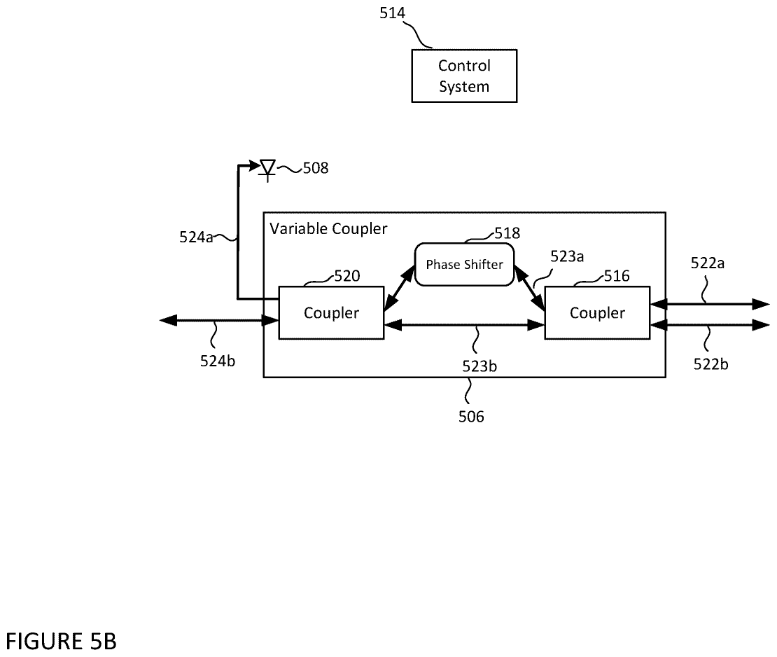

As discussed above, an optical communications terminal may include one or more variable couplers to assist in the distribution of optical signals or beams across pathways (e.g., waveguides, optical fibers) within the optical communications terminal. FIG. 5A illustrates an example architecture 500 including a plurality of variable couplers 506a-c of an optical communications terminal such as optical communications terminal 102, 122. In some instances, the variable couplers may be configured as Mach-Zehnder interferometers (MZI). The example architecture 500 also includes a plurality of emitters or antennas 502a-d, a plurality of phase shifters 504a-c, a plurality of photodetectors 508a-c, an edge coupler 520, a camera 512, and control system 514. One or more of the components of the example architecture 500 may be connected via one or more waveguides. As noted above, the optical communications terminal including example architecture 500 may be a bi-directional optical communications terminal. In this regard, the optical communications terminal may be configured to transmit and receive signals or beams to and from remote optical communications terminals. Received signals may be propagated through the terminal in a receive direction 501 (e.g., in a direction of signals received by the optical communications terminal as described above) and transmitted signals may be propagated through the terminal in a transmit direction 503 (e.g., in a direction of signals transmitted by the optical communications terminal as described above).

In a receive direction 501, received signals (e.g., optical communications beams or signals) may be received at the plurality of emitters 502a-d. Emitters 502a-d may be configured in the same or similar manner as emitters 320 as discussed with respect to FIG. 3. Portions of a received signal may be directed from the plurality of emitters 502a-d towards variable couplers 506a-b. Portions of the received signal may be adjusted by phase shifters 504a-b disposed in a path of portions of the received signal. The phase shifters 504a-b may be configured in the same or similar manner as phase shifters 330 discussed with respect to FIG. 3. In this regard, phase shifter 504a is disposed in a path between emitter 502a and variable coupler 506a. Similarly, phase shifter 504b is disposed in a path between emitter 502c and variable coupler 506b. The portions of the received signal passing through phase shifters 504a-b may be adjusted by phase shifters 504a-b such that the portions to be combined at variable couplers 506a-b are in the correct phase (e.g., in phase when combined) to avoid interference. The phase shifters 504a-b may be operatively connected to the control system 514. Control system 514 may include one or more processors (e.g., one or more processors 104). The control system 514 may be configured to drive the phase shifters 504a-b to adjust portions of the received signal passing therethrough. In some instances, the paths between each emitter 502a-d and a respective variable coupler 506a-b may include a phase shifter like phase shifters 504a-b to adjust portions of the received signal. While the example architecture 500 only includes one layer of emitters 502a-c, an optical communications terminal may include a plurality of layers of emitters.

Variable couplers 506a-b may be configured as 2×2 couplers including two inputs and two outputs. The variable couplers 506a-b may be configured to variably split the sum of received signals input therein between output paths based on one or more command signals from the control system 514 operatively coupled thereto. For example, variable coupler 506a may receive a 100 mW portion of a received signal from emitter 502a and a 100 mW portion of the received signal from emitter 502b. The sum of the inputs (e.g., the portions of the received signal) in such an example would be a 200 mW signal.

The variable coupler 506a may also be configured to variably split the 200 mW signal between an output directed towards photodetector 508a (e.g., photodiode) and an output directed towards variable coupler 506c based on a control signal from the control system 514. In another example, variable coupler 506a may receive a 100 mW portion of a received signal from emitter 502a and a 0 mW portion of the received signal from emitter 502b. The sum of the inputs in such an example would be a 100 mW signal.

The variable coupler 506a may also be configured to variably split the 100 mW signal between an output directed towards photodetector 508a (e.g., photodiode) and an output directed towards variable coupler 506c based on a control signal from the control system 514. In such an example where one of the inputs is 0 mW or approximately 0 mW, an obstruction or obstacle may be present preventing the corresponding emitter from receiving a portion of the received signal.

The split of the received signal between outputs of a variable coupler may be any amount. In one example, 100% of the respective portions of a received signal input into the variable couplers 506a-b may be directed towards variable coupler 506c and 0% of the respective portions of the received signal input into the variable couplers 506a-b may be directed towards photodetectors 508a-b. In this regard, if the sum of the respective portions of the received signal is a 200 mW signal, 200 mW may be directed towards variable coupler 506c and 0 mW may be directed towards photodetectors 508a-b. Alternatively, if the sum of the respective portions of the received signals is a 100 mW signal, 100 mW may be directed towards variable coupler 506c and 0 mW may be directed towards photodetectors 508a-b.

In another example, 50% of the respective portions of a received signal input into the variable couplers 506a-b may be directed towards variable coupler 506c and 50% of the respective portions of the received signal input into the variable couplers 506a-b may be directed towards photodetectors 508a-b. In this regard, if the sum of the respective portions of the received signal is a 200 mW signal, 100 mW may be directed towards variable coupler 506c and 100 mW may be directed towards photodetectors 508a-b. Alternatively, if the sum of the respective portions of the received signals is a 100 mW signal, 50 mW may be directed towards variable coupler 506c and 50 mW may be directed towards photodetectors 508a-b.

In a further example, 0% of the respective portions of a received signal input into the variable couplers 506a-b may be directed towards variable coupler 506c and 100% of the respective portions of the received signal input into the variable couplers 506a-b may be directed towards photodetectors 508a-b. In this regard, if the sum of the respective portions of the received signals is a 200 mW signal, 0 mW may be directed towards variable coupler 506c and 200 mW may be directed towards photodetectors 508a-b. Alternatively, if the sum of the respective portions of the received signals is a 100 mW signal, 0 mW may be directed towards variable coupler 506c and 100 mW may be directed towards photodetectors 508a-b.

The splitting ratios or percentages in the above examples are provided as non-exhaustive examples. Any other splitting ratios or percentages that sum to the total signal may be used and may be determined based on the one or more command signals from the control system.

Portions of the received signal directed towards the photodetectors 508a-b may be used as feedback by the control system 514. In this regard, the control system may be operatively connected to the photodetectors 508a-b and be configured to generate control signals to the various components of the architecture 500 based on measures from the photodetectors 508a-b.

Variable coupler 506c may be configured to receive portions of the received signal from outputs of the variable couplers 506a-506b. A portion of the received signal may be adjusted by phase shifter 504c disposed in a path of the portion of the received signal. The phase shifter 504c may be configured in the same or similar manner as phase shifters 330 discussed with respect to FIG. 3. In this regard, phase shifter 504c is disposed in a path between variable coupler 506c and variable coupler 506a. The portion of the received signal passing through phase shifter 504c may be adjusted by phase shifter 504c such that the portions to be combined at variable coupler 506c are in the correct phase (e.g., in phase when combined) to avoid interference. The phase shifter 504c may be operatively connected to the control system 514. The control system 514 may be configured to drive the phase shifter 504c to adjust portions of the received signal passing therethrough. In some instances, the paths between each of variable couplers 506a-b and variable coupler 506c may include a phase shifter like phase shifter 504c to adjust portions of the received signal.

Like variable couplers 506a-b, variable coupler 506c may be configured as a 2 x2 coupler including two inputs and two outputs. The variable coupler 506c may be configured to variably split the sum of received signals input therein between output paths based on one or more command signals from the control system 514 operatively coupled thereto. For example, variable coupler 506c may receive a 100 mW portion of a received signal from variable coupler 506a and a 100 mW portion of the received signal from variable coupler 506b. The sum of the inputs(e.g., the portions of the received signal) in such an example would be a 200 mW signal. The variable coupler 506c may be configured to variably split the 200 mW signal between an output directed towards photodetector 508c (e.g., photodiode) and an output directed towards edge coupler 510 based on a control signal from the control system 514. Edge coupler 510 may be configured to direct received signals towards other portions of the optical communications terminal such as, for example, one or more receiver components (e.g., sensor 138).

The split of the received signal between outputs of a variable coupler may be any amount. In one example, 100% of the respective portions of a received signal input into the variable coupler 506c may be directed towards edge coupler 510 and 0% of the respective portions of the received signal input into the variable coupler 506c may be directed towards photodetector 508c. In this regard, if the sum of input signals is a 200 mW signal, 200 mW may be directed towards edge coupler 510 and 0 mW may be directed towards photodetector 508c. Alternatively, if the sum of the respective portions of the received signals is a 100 mW signal, 100 mW may be directed towards edge coupler 510 and 0 mW may be directed towards photodetector 508c.

In another example, 50% of the respective portions of a received signal input into the variable coupler 506c may be directed towards edge coupler 510 and 50% of the respective portions of the received signal input into the variable coupler 506c may be directed towards photodetector 508c. In this regard, if the sum of the respective portions of the received signals is a 200 mW signal, 100 mW may be directed towards edge coupler 510 and 100 mW may be directed towards photodetector 508c. Alternatively, if the sum of the respective portions of the received signals is a 100 mW signal, 50 mW may be directed towards edge coupler 510 and 50 mW may be directed towards photodetector 508c.

In a further example, 0% of the respective portions of a received signal input into the variable coupler 506c may be directed towards edge coupler 510 and 100% of the respective portions of the received signal input into the variable coupler 506c may be directed towards photodetector 508c. In this regard, if the sum of the respective portions of the received signals is a 200 mW signal, 0 mW may be directed towards edge coupler 510 and 200 mW may be directed towards photodetector 508c. Alternatively, if the sum of the respective portions of the received signals is a 100 mW signal, signal 0 mW may be directed towards edge coupler 510 and 100 mW may be directed towards photodetector 508c.

The splitting ratios or percentages in the above examples are provided as non-exhaustive examples. Any other splitting ratios or percentages that sum to the total signal may be used and may be determined based on the one or more command signals from the control system.

Portions of the received signal directed towards the photodetector 508c may be used as feedback by the control system 514. In this regard, the control system may be operatively connected to the photodetector 508c and be configured to generate control signals to the various components of the architecture 500 based on measures from the photodetector 508c.

In a transmit direction 503, transmitted signals (e.g., optical communications beams or signals) may be received at edge coupler 510 from one or more transmitter components of the optical communications terminal (e.g., a light source, such as seed laser 116). The transmitted signals may be directed from edge coupler 510 to variable coupler 506c. In the transmit direction 503, the variable coupler 506c may be configured to split transmitted signals between two outputs thereof. The outputs may direct split portions of the transmitted signals towards variable coupler 506a and variable coupler 506b respectively. A portion of the transmitted signal may be adjusted by phase shifter 504c disposed in a path of the portion of the transmitted signal. In this regard, phase shifter 504c is disposed in a path between variable coupler 506c and variable coupler 506a. The portion of the transmitted signal passing through phase shifter 504c may be adjusted by phase shifter 504c such that the portion directed towards variable coupler 506a and the portion directed towards variable coupler 506b are in the correct phase for transmission. The phase shifter 504c may be operatively connected to the control system 514. The control system 514 may be configured to drive the phase shifter 504c to adjust portions of the transmitted signal passing therethrough. In some instances, the paths between each of variable couplers 506a-b and variable coupler 506c may include a phase shifter like phase shifter 504c to adjust portions of the transmitted signal.

In the transmit direction, the variable coupler 506c may be configured as a 1×2 coupler including one input and two outputs. The variable coupler 506c may be configured to variably split the transmitted signals input therein between output paths based on one or more command signals from the control system 514 operatively coupled thereto. For example, variable coupler 506c may receive a 200 mW signal from the edge coupler 510. The variable coupler 506c may be configured to variably split the 200 mW signal between an output directed towards variable coupler 506a and an output directed towards variable coupler 506b based on a control signal from the control system 514.

The split of the transmitted signal between outputs of a variable coupler may be any amount. In one example, 100% of a transmitted signal input into the variable coupler 506c may be directed towards variable coupler 506a and 0% of the transmitted signal input into the variable coupler 506c may be directed towards variable coupler 506b. If the transmitted signal input is a 200 mW signal, 200 mW may be directed towards variable coupler 506a and 0 mW may be directed towards variable coupler 506b.

In another example, 50% of the transmitted signal input into the variable coupler 506c may be directed towards variable coupler 506a and 50% of transmitted signal input into the variable coupler 506c may be directed towards variable coupler 506b. In this regard, if a transmitted signal input is a 200 mW signal, 100 mW may be directed towards variable coupler 506a and 100 mW may be directed towards variable coupler 506b.

In a further example, 0% of the transmitted signal input into the variable coupler 506c may be directed towards variable coupler 506a and 100% of the transmitted signal input into the variable coupler 506c may be directed towards variable coupler 506b. In this regard, if the transmitted signal input is a 200 mW signal, 0 mW may be directed towards variable coupler 506a and 200 mW may be directed towards variable coupler 506b. The splitting ratios or percentages in the above examples are only examples. In this regard, the splitting ratio may be any ratio based on the one or more command signals from the control system.

Further in the transmit direction, variable couplers 506a-b, like variable coupler 506c, may be configured to split transmitted signals between two outputs thereof. The outputs may direct split portions of the transmitted signals towards emitters 502a-d. Portions of a transmitted signal may be adjusted by phase shifters 504a-b disposed in a path of the portions of the transmitted signal. In this regard, phase shifter 504a is disposed in a path between variable coupler 506a and emitter 502a and phase shifter 504b is disposed in a path between variable coupler 506b and emitter 502c. The portions of the transmitted signal passing through phase shifters 504a-b may be adjusted by phase shifters 504a-b such that the portions directed towards emitters 502a-are in the correct phase for transmission. The phase shifters 504a-b may be operatively connected to the control system 514. The control system 514 may be configured to drive the phase shifters 504a-b to adjust portions of the transmitted signal passing therethrough. In some instances, the paths between each of variable couplers 506a-b and emitters 502b, 502d may include a phase shifter like phase shifters 504a-b to adjust portions of the transmitted signal.

In the transmit direction, the variable couplers 506a-b, like variable coupler 506c, may be configured as a 1×2 coupler including one input and two outputs. The variable couplers 506a-b may be configured to variably split the transmitted signals input therein between output paths based on one or more command signals from the control system 514 operatively coupled thereto. For example, variable coupler 506a may receive a 200 mW signal from variable coupler 506c. The variable coupler 506a may be configured to variably split the 200 mW signal between an output directed towards emitter 502a and an output directed towards emitter 502b based on a control signal from the control system 514

The split of the transmitted signal between outputs of a variable coupler may be any amount. In one example, 100% of a transmitted signal input into the variable coupler 506a may be directed towards emitter 502a and 0% of the transmitted signal input into the variable coupler 506a may be directed towards emitter 502b. If the transmitted signal input is a 200 mW signal, 200 mW may be directed towards emitter 502a and 0 mW may be directed towards emitter 502b.

In another example, 50% of the transmitted signal input into the variable coupler 506a may be directed towards emitter 502a and 50% of the transmitted signal input into the variable coupler 506a may be directed towards emitter 502b. In this regard, if the transmitted signal input is a 200 mW signal, 100 mW may be directed towards emitter 502a and 100 mW may be directed towards emitter 502b.

In a further example, 0% of the transmitted signal input into the variable coupler 506a may be directed towards emitter 502 and 100% of the transmitted signal input into the variable coupler 506a may be directed towards emitter 502b. In this regard, if the transmitted signal input is a 200 mW signal, 0 mW may be directed towards emitter 502a and 200 mW may be directed towards emitter 502b. In some instances, 0 mW or approximately 0 mW of a transmitted signal may be directed to one or more emitters for transmission if an obstacle is known to be in the path of the one or more emitters. The obstacle may be known to be in the path based on, for example, power distribution of a prior received signal.

The splitting ratios or percentages in the above examples are provided as non-exhaustive examples. Any other splitting ratios or percentages that sum to the total signal may be used and may be determined based on the one or more command signals from the control system.

Camera 512 may be operatively connected to the control system 514. In this regard, the cameras 512 may be configured to send one or more measurements pertaining to pointing directions of the emitters 502a-d. The control system 514 may be configured to adjust the one or more of the emitters 502a-d to improve alignments, adjust a pointing direction thereof, etc. based on the one or more measurements.

In some instances, variable couplers 506a-b of the example architecture 500 may be couplers (e.g., fixed couplers). In this regard, variable couplers (e.g., variable coupler 506c) may only be included downstream from the one or more emitters 502a within an example architecture. Couplers may be configured as 2×2 couplers that evenly split the sum of signals input therein between output paths.

FIG. 5B illustrates an example configuration of a variable coupler 506 (i.e., variable couplers 506a-c). Variable coupler 506 may include a first coupler 516 a second coupler 520 and a phase shifter 518. The variable coupler and the components thereof may be operatively connected to control system 514. In a receive direction, variable coupler 506 may receive portions of a received signal at inputs 522a-b. The inputs may propagate received signals towards coupler 516. Coupler 516 may be a 2×2 coupler. Coupler 516 may output portions of the received signal towards coupler 520 via a first path 523a and a second path 523b. Like coupler 516, coupler 520 may be a 2×2 coupler. Phase shifter 518 is disposed in the first path 523a between coupler 516 and coupler 520. The portion of the received signal passing through phase shifter 518 may be adjusted by phase shifter 518 such that the portions of the received signal to be combined at coupler 520 interfere such that a desired ratio of portions of the signal are output at path 524a towards photodetector 508 path 524b to other components of the architecture 500. The phase shifter 518 may be operatively connected to the control system 514. The control system 514 may be configured to drive the phase shifter 518 to adjust portions of the received signal passing therethrough.

In a transmit direction, variable coupler 506 may receive portions of a transmitted signal at input 524b. The input may propagate the transmitted signal towards coupler 520. Coupler 516 may be a 1×2 coupler in the transmit direction. Coupler 520 may output portions of the transmitted signal towards coupler 516 via first path 523a and second path 523b. Coupler 520 may be a 2×2 coupler in the transmit direction. Phase shifter 518 is disposed in the first path 523a between coupler 516 and coupler 520. The portion of the transmitted signal passing through phase shifter 518 may be adjusted by phase shifter 518 such that the portions to be combined at coupler 516 interfere such that a desired ratio of portions of the transmitted signal are output at paths 522a-b towards other components of the architecture 500. The phase shifter 518 may be operatively connected to the control system 514. The control system 514 may be configured to drive the phase shifter 518 to adjust portions of the transmitted signal passing therethrough. For instance, the control system 514 may utilize the readout of optical power levels on photodiode 508 in order to set appropriate feedback control levels for the phase shifter 518.

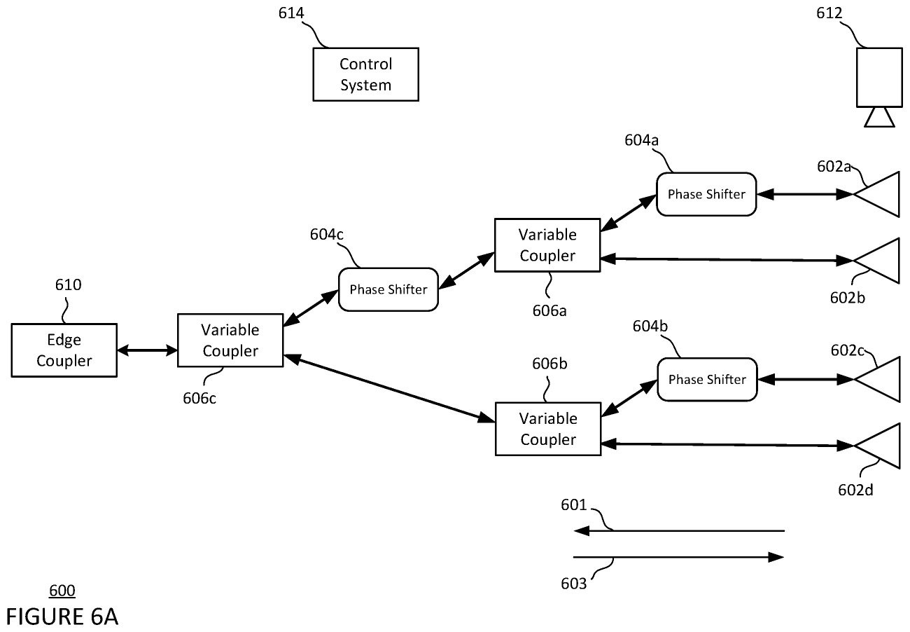

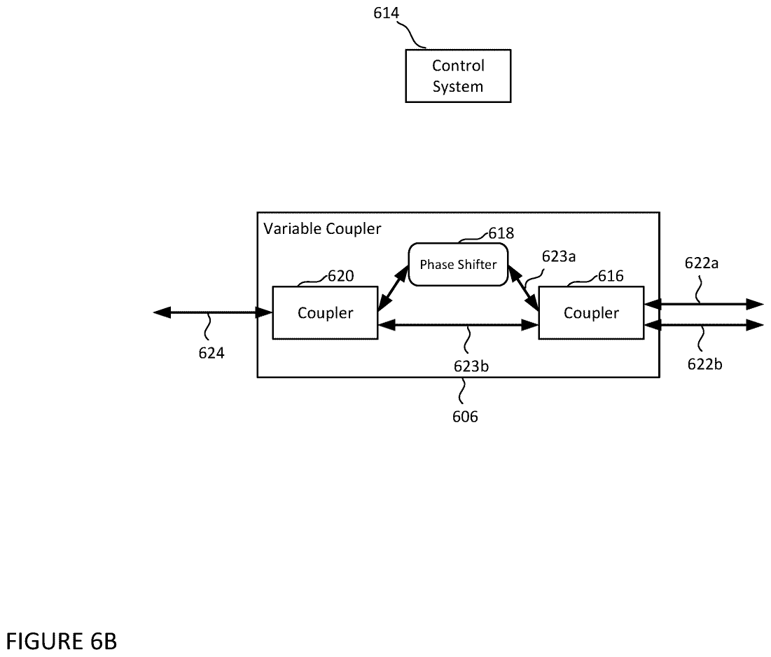

In some instances, an optical communications terminal including one or more variable couplers to assist in the distribution of optical signals or beams across pathways (e.g., waveguides, optical fibers) within the optical communications terminal may not include photodetectors (e.g., photodetectors 508a-c) connected to outputs of one or more variable couplers. FIG. 6A illustrates an example architecture 600 including a plurality of variable couplers 606a-c of an optical communications terminal (e.g., optical communications terminal 102, 122) without operatively connected to the variable couplers 606a-c. Similarly, FIG. 6B illustrates an example configuration of a variable coupler 606 (i.e., variable couplers 606a-c), variable coupler 606 not being connected to a photodetector at an output thereof. The example architecture 600 also includes a plurality of emitters or antennas 602a-d, a plurality of phase shifters 604a-c, an edge coupler 620, a camera 612, and control system 614. One or more of the components of the example architecture 600 may be connected via one or more waveguides. As noted above, the optical communications terminal including example architecture 600 may be a bi-directional optical communications terminal. In this regard, the optical communications terminal may be configured to transmit and receive signals or beams to and from remote optical communications terminals. Received signals may be propagated through the terminal in a receive direction 601 and transmitted signals may be propagated through the terminal in a transmit direction 603. The plurality of emitters or antennas 602a-d may be configured in the same or similar manner as emitters 502a-d, the plurality of phase shifters 604a-c may be configured in the same or similar manner as phase shifters 504a-c, the plurality of variable couplers 606a-c may be configured in the same or similar manner as variable couplers 506a-c, the edge coupler 620 may be configured in the same or similar manner as edge coupler 520, the camera 612 may be configured in the same or similar manner as camera 512, and the control system 614 may be configured in the same or similar manner as control system 514.

In a receive direction 601, received signals (e.g., optical communications beams or signals) may be received at the plurality of emitters 602a-d. Emitters 602a-d may be configured in the same or similar manner as emitters 320 as discussed with respect to FIG. 3. Portions of a received signal may be directed from the plurality of emitters 602a-d towards variable couplers 606a-b. Portions of the received signal may be adjusted by phase shifters 604a-b disposed in a path of portions of the received signal. The phase shifters 604a-b may be configured in the same or similar manner as phase shifters 330 discussed with respect to FIG. 3. In this regard, phase shifter 604a is disposed in a path between emitter 602a and variable coupler 606a. Similarly, phase shifter 604b is disposed in a path between emitter 602c and variable coupler 606b. The portions of the received signal passing through phase shifters 604a-b may be adjusted by phase shifters 604a-b such that the portions to be combined at variable couplers 606a-b are in the correct phase (e.g., in phase when combined) to avoid interference. The phase shifters 604a-b may be operatively connected to the control system 614. Control system 614 may include one or more processors (e.g., one or more processors 104). The control system 614 may be configured to drive the phase shifters 604a-b to adjust portions of the received signal passing therethrough. In some instances, the paths between each emitter 602a-d and a respective variable coupler 606a-b may include a phase shifter like phase shifters 604a-b to adjust portions of the received signal. While the example architecture 500 only includes one layer of emitters 602a-c, an optical communications terminal may include a plurality of layers of emitters.

In a receive direction, variable couplers 606a-b may be configured as 1×2 couplers including two inputs and one output. In this regard, variable couplers 606a-b may combine received signals input therein and output the combination of thereof. The variable couplers 606a-b may be configured to apply a dither to received signals passing therethrough. The dither may be a perturbation or noise injected onto the propagating signal. The dither, including changes thereto due to the propagation of the received signal through the optical communications terminal, may be measured downstream at, for example, one or more receiver components (e.g., sensor 138). The measurements regarding the dither may be used as feedback by the control system 614. In this regard, the control system may be configured to generate control signals to the various components of the architecture 600 based on the measurements regarding the dither.

For instance, dithers may be applied or impressed on the received signals by modulating the drive voltage or current on phase shifters at the different phase shifters 604a, 604b, 604c. The dithers may be employed using an orthonormal basis set, such as greyscale Walsh functions or Zernike polynomials, to determine the appropriate control set points for the phase shifter 518 within each variable coupler 606a-b.

Variable coupler 606c may be configured to receive portions of the received signal from outputs of the variable couplers 606a-606b. A portion of the received signal may be adjusted by phase shifter 604c disposed in a path of the portion of the signal. The phase shifter 604c may be configured in the same or similar manner as phase shifters 330 discussed with respect to FIG. 3. In this regard, phase shifter 604c is disposed in a path between variable coupler 606c and variable coupler 606a. The portion of the received signal passing through phase shifter 604c may be adjusted by phase shifter 604c such that the portions to be combined at variable coupler 606c are in the correct phase (e.g., in phase when combined) to avoid interference. The phase shifter 604c may be operatively connected to the control system 614. The control system 614 may be configured to drive the phase shifter 604c to adjust portions of the received signal passing therethrough. In some instances, the paths between each of variable couplers 606a-b and variable coupler 606c may include a phase shifter like phase shifter 604c to adjust portions of the received signal.

Like variable couplers 606a-b, in the receive direction variable coupler 606c may be configured as a 1×2 coupler including two inputs and one output. In this regard, variable coupler 606c may combine received signals input therein and output the combination of thereof. The variable coupler 606c may be configured to apply a dither to received signals passing therethrough. The dither may be a perturbation or noise injected onto the propagating signal applied as described above. The dither, including changes thereto due to the propagation of the received signal through the optical communications terminal, may be measured downstream at, for example, one or more receiver components (e.g., sensor 138). The measurements regarding the dither may be used as feedback by the control system 614. In this regard, the control system may be configured to generate control signals to the various components of the architecture 600 based on the measurements regarding the dither.

Variable coupler 606c may direct received signals to edge coupler 610 may be configured to direct received signals towards other portions of the optical communications terminal such as, for example, one or more receiver components (e.g., sensor 138).

In a transmit direction 603, transmitted signals (e.g., optical communications beams or signals) may be received at edge coupler 610 from one or more transmitter components of the optical communications terminal (e.g., a light source, such as seed laser 116). The transmitted signals may be directed from edge coupler 610 to variable coupler 606c. In the transmit direction 603, the variable coupler 606c may be configured to split transmitted signals between two outputs thereof. The outputs may direct split portions of the transmitted signals towards variable coupler 606a and variable coupler 606b respectively. A portion of the transmitted signal may be adjusted by phase shifter 604c disposed in a path of the portion of the transmitted signal. In this regard, phase shifter 604c is disposed in a path between variable coupler 606c and variable coupler 606a. The portion of the transmitted signal passing through phase shifter 604c may be adjusted by phase shifter 604c such that the portion directed towards variable coupler 606a and the portion directed towards variable coupler 606b are in the correct phase for transmission. The phase shifter 604c may be operatively connected to the control system 614. The control system 614 may be configured to drive the phase shifter 604c to adjust portions of the transmitted signal passing therethrough. In some instances, the paths between each of variable couplers 606a-b and variable coupler 606c may include a phase shifter like phase shifter 604c to adjust portions of the transmitted signal.

In the transmit direction, the variable coupler 606c may be configured as a 1×2 coupler including one input and two outputs. The variable coupler 606c may be configured to variably split the transmitted signals input therein between outputs of thereof based on one or more command signals from the control system 614 operatively coupled thereto. For example, variable coupler 606c may receive a 200 mW signal from the edge coupler 610. The variable coupler 606c may be configured to variably split the 200 mW signal between an output directed towards variable coupler 606a and an output directed towards variable coupler 606b based on a control signal from the control system 614.

The split of the transmitted signal between outputs of a variable coupler may be any amount. In one example, 100% of a transmitted signal input into the variable coupler 606c may be directed towards variable coupler 606a and 0% of the transmitted signal input into the variable coupler 606c may be directed towards variable coupler 606b. If the transmitted signal input is a 200 mW signal, 200 mW may be directed towards variable coupler 606a and 0 mW may be directed towards variable coupler 606b.

In another example, 50% of the transmitted signal input into the variable coupler 606c may be directed towards variable coupler 606a and 50% of the transmitted signal input into the variable coupler 606c may be directed towards variable coupler 606b. In this regard, if the transmitted signal input is a 200 mW signal, 100 mW may be directed towards variable coupler 606a and 100 mW may be directed towards variable coupler 606b.

In a further example, 0% of the transmitted signal input into the variable coupler 606c may be directed towards variable coupler 606a and 100% of the transmitted signal input into the variable coupler 606c may be directed towards variable coupler 606b. In this regard, if the transmitted signal input is a 200 mW signal, 0 mW may be directed towards variable coupler 606a and 200 mW may be directed towards variable coupler 606b. The splitting ratios or percentages in the above examples are only examples. In this regard, the splitting ratio may be any ratio based on the one or more command signals from the control system.

Further in the transmit direction, variable couplers 606a-b, like variable coupler 606c, may be configured to split transmitted signals between two outputs. The outputs may direct split portions of the signals towards emitters 602a-d. Portions of a transmitted signal may be adjusted by phase shifters 604a-b disposed in a path of the portions of the transmitted signal. In this regard, phase shifter 604a is disposed in a path between variable coupler 606a and emitter 602a and phase shifter 604b is disposed in a path between variable coupler 606b and emitter 602c. The portions of the transmitted signal passing through phase shifters 604a-b may be adjusted by phase shifters 604a-b such that the portions directed towards emitters 602a-are in the correct phase for transmission. The phase shifters 604a-b may be operatively connected to the control system 614. The control system 614 may be configured to drive the phase shifters 604a-b to adjust portions of the transmitted signal passing therethrough. In some instances, the paths between each of variable couplers 606a-b and emitters 602b, 602d may include a phase shifter like phase shifters 604a-b to adjust portions of the transmitted signal.

In the transmit direction, the variable couplers 606a-b, like variable coupler 606c, may be configured as a 1×2 coupler including one input and two outputs. The variable couplers 606a-b may be configured to variably split the transmitted signals input therein between output paths based on one or more command signals from the control system 614 operatively coupled thereto. For example, variable coupler 606a may receive a 200 mW signal from variable coupler 606c. The variable coupler 606a may be configured to variably split the 200 mW signal between an output directed towards emitter 602a and an output directed towards emitter 602b based on a control signal from the control system 614

The split of the transmitted signal between outputs of a variable coupler may be any amount. In one example, 100% of a transmitted signal input into the variable coupler 606a may be directed towards emitter 602a and 0% of the transmitted signal input into the variable coupler 606a may be directed towards emitter 602b. If the transmitted signal input is a 200 mW signal, 200 mW may be directed towards emitter 602a and 0 mW may be directed towards emitter 602b.

In another example, 50% of the transmitted signal input into the variable coupler 606a may be directed towards emitter 602a and 50% of the transmitted signal input into the variable coupler 606a may be directed towards emitter 602b. In this regard, if the transmitted signal input into is a 200 mW signal, 100 mW may be directed towards emitter 602a and 100 mW may be directed towards emitter 602b.

In a further example, 0% of the transmitted signal input into the variable coupler 606a may be directed towards emitter 602 and 100% of the transmitted signal input into the variable coupler 606a may be directed towards emitter 602b. In this regard, if the transmitted signal input is a 200 mW signal, 0 mW may be directed towards emitter 602a and 200 mW may be directed towards emitter 602b. In some instances, 0 mW or approximately 0 mW of a transmitted signal may be directed to one or more emitters for transmission if an obstacle is known to be in the path of the one or more emitters. The obstacle may be known to be in the path based on, for example, power distribution of a prior received signal.

The splitting ratios or percentages in the above examples are provided as non-exhaustive examples. Any other splitting ratios or percentages that sum to the total signal may be used and may be determined based on the one or more command signals from the control system.

Camera 612 may be operatively connected to the control system 614. In this regard, the cameras 612 may be configured to send one or more measurements pertaining to pointing directions of the emitters 602a-d. The control system 614 may be configured to adjust the one or more of the emitters 602a-d to improve alignments, adjust a pointing direction thereof, etc. based on the one or more measurements.

In some instances, variable couplers 606a-b of the example architecture 600 may be couplers (e.g., fixed couplers). In this regard, variable couplers (e.g., variable coupler 606c) may only be included downstream from the one or more emitters 602a within an example architecture. Couplers may be configured as 2×2 couplers that evenly split the sum of signals input therein between output paths.

FIG. 6B illustrates an example configuration of a variable coupler 606 (i.e., variable couplers 606a-c). Variable coupler 606 may include a first coupler 616 a second coupler 620 and a phase shifter 618. The variable coupler and the components thereof may be operatively connected to control system 614. In a receive direction, variable coupler 606 may receive portions of a received signal at inputs 622a-b. The inputs may propagate received signals towards coupler 616. Coupler 616 may be a 2×2 coupler. Coupler 616 may output portions of the received signal towards coupler 620 via a first path 623a and a second path 623b. Coupler 620 may be a 1×2 coupler. Phase shifter 618 is disposed in the first path 623a between coupler 616 and coupler 620. The portion of the received signal passing through phase shifter 618 may be adjusted by phase shifter 618 such that the portions to be combined at coupler 620 interfere in a desired manner (e.g., constructively) such that the resultant signal is output at path 524 towards other components of the architecture 600.

In a receive direction, phase shifter 618 may be configured to apply a dither to received signals passing therethrough. The dither may be a perturbation or noise injected onto the propagating signal applied as described above. The dither, including changes thereto due to the propagation of the received signal through the optical communications terminal, may be measured downstream at, for example, one or more receiver components (e.g., sensor 138). The measurements regarding the dither may be used as feedback by the control system 614. In this regard, the control system may be configured to generate control signals to the various components of the architecture 600 based on the measurements regarding the dither.

The phase shifter 618 may be operatively connected to the control system 614. The control system 614 may be configured to drive the phase shifter 618 to adjust portions of the received signal passing therethrough and/or apply a dither thereto.

In a transmit direction, variable coupler 606 may receive portions of a transmitted signal at input 624. The input 624 may propagate the transmitted signal towards coupler 620. Coupler 616 may be a 1×2 coupler in the transmit direction. Coupler 620 may output portions of the signal towards coupler 616 via first path 623a and second path 623b. Coupler 620 may be a 2×2 coupler in the transmit direction. Phase shifter 618 is disposed in the first path 623a between coupler 616 and coupler 620. The portion of the transmitted signal passing through phase shifter 618 may be adjusted by phase shifter 618 such that the portions to be combined at coupler 616 interfere such that a desired ratio of portions of the transmitted signal are output at paths 622a-b towards other components of the architecture 600. The phase shifter 618 may be operatively connected to the control system 614. The control system 614 may be configured to drive the phase shifter 618 to adjust portions of the transmitted signal passing therethrough.

For instance, the combination of the phase shifters 604a-c and variable couplers 606a-c may be utilized to optimize the signal received at edge coupler 610. Alternatively, the combination of the phase shifters 604a-c and variable couplers 606a-c may be utilized to optimally configure the transmit beam at the emitters 602a-d to pre-compensate the transmit beam to avoid any obscurations.

### Example Methods

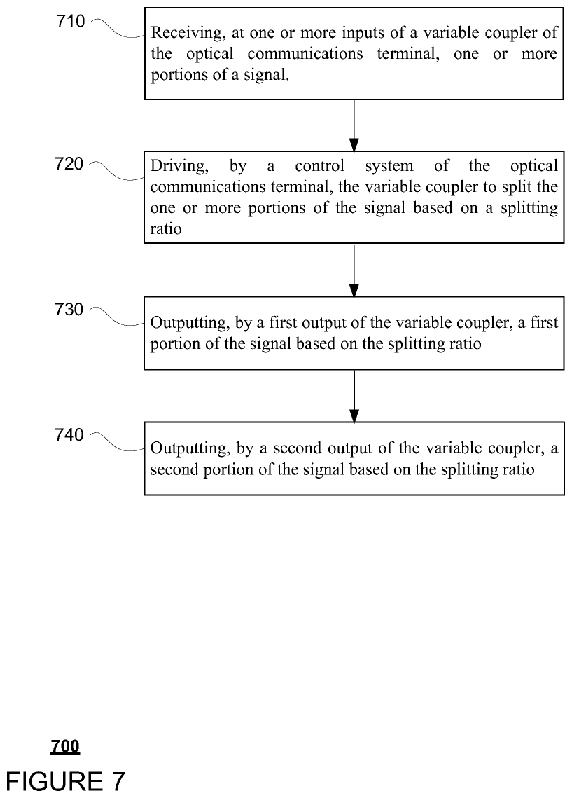

The systems described above may be used in a method of variably splitting a signal (e.g., optical communications signal or beam) as it propagates through an optical communications terminal. FIG. 7 illustrates an example method 700 of variably splitting a signal. At block 710, the method includes receiving, at one or more inputs of a variable coupler of the optical communications terminal, one or more portions of a signal. As discussed above, in a receive direction 501,601 a variable coupler 506, 606 include may include one or more inputs 522a-b configured to input one or more portions of a received signal. The one or more inputs 522a-b may be connected to portions of an example architecture 500, 600 of an optical communications terminal (e.g., optical communications terminal 102, 122). The portions of the optical terminal may include emitters 502a-d, 602a-d, other variable couplers (e.g., variable couplers 506a-b, 606a-b), etc.

Also as discussed above, in a transmit direction 503,603 a variable coupler 506, 606 include may include one or more inputs 524b, 624 configured to input one or more portions of a transmitted signal. The one or more inputs 524b, 624 may be connected to portions of an example architecture 500, 600 of an optical communications terminal (e.g., optical communications terminal 102, 122). The portions of the optical communications terminal may include an edge coupler 510,610 (e.g., variable coupler 506c, 606c), etc.

At block 720, the method includes, driving, by a control system of the optical communications terminal, the variable coupler to split the one or more portions of the signal based on a splitting ratio. The splitting may be done in both a transmit direction 503, 603 and a receive direction 501. As discussed above, a control system 514, 614 may be operatively connected to the variable couplers 506, 606 of the example architecture 500, 600 of the optical communications terminal (e.g., optical communications terminal 102, 122). In this regard, the control system 514, 614 may be configured to drive the variable couplers 506, 606, and the components thereof, to variably split signals input therein between outputs thereof based on a splitting ratio (e.g., 0%/100%; 50%/50%; 100%/50%; etc.) as discussed above. In some instances, the control system 514 may be configured to control the variable couplers 506 based on one or more measures from photodetectors 508a-c. In this regard, portions of signals directed towards the photodetectors 508a-b may be used as feedback by the control system 514. The control system 514 may be operatively connected to the photodetectors 508a-b and be configured to generate control signals to the various components, including variable coupler 506 of the architecture 500 based on measures from the photodetectors 508a-b. In this regard, the control system may drive the variable couplers variably split signals based on one or more measures from photodetectors 508a-c (e.g., at a previous timestep).

In some instances, the control system 614 may be configured to control the variable couplers 606 to apply a dither to signals passing therethrough. The dither may be a perturbation or noise injected onto the propagating signal applied as described above. The dither, including changes thereto due to the propagation of the signal through the optical communications terminal, may be measured downstream at, for example, one or more receiver components (e.g., sensor 138). The measurements regarding the dither may be used as feedback by the control system 614. In some examples, the control system 614 may be configured to generate control signals to the various components, such as the variable couplers 606, of the architecture 600 based on the measurements regarding the dither. In this regard, the control system may drive the variable couplers to inject dithers into signals and/or variably split signals based on the measurements regarding the dither (e.g., at a previous timestep).

At block 730, the method includes outputting, by a first output of the variable coupler, a first portion of the signal based on the splitting ratio. At block 740, the method includes outputting, by a second output of the variable coupler, a second portion of the signal based on the splitting ratio. As discussed above, the control system 514, 614 may be configured to drive the variable couplers 506, 606, and the components thereof, to variably split signals input therein to outputs thereof based on a splitting ratio (e.g., 0%/100%; 50%/50%; 100%/50% etc.) as discussed above. The splitting may be done in both a transmit direction 503, 603 and a receive direction 501. As discussed above, in a receive direction 501 the variable coupler 506 include may include one or more outputs 524a-b configured to output portions of the received signal based on the splitting ratio. The one or more outputs 524a-b may be connected to portions of an example architecture 500 of an optical communications terminal (e.g., optical communications terminal 102, 122). The portions of the optical communications terminal may include photodetectors 508a-c, other variable couplers (e.g., variable coupler 506c), edge coupler 510 etc.

Also as discussed above, in a transmit direction 503, 603 a variable coupler 506, 606 include may include one or more outputs 522a-b, 622a-b configured to output portions of a transmitted signal based on the splitting ratio. The one or more outputs 522a-b, 622a-b may be connected to portions of an example architecture 500, 600 of an optical communications terminal (e.g., optical communications terminal 102, 122). The portions of the optical communications terminal may include other variable couplers (e.g., variable couplers 506a-b, 606a-b), emitters 502a-d, 602a-d, etc.

The systems and methodology described herein allow for variable splitting of signals throughout an optical communications terminal. The variable splitting may allow for maximizing received power even when obstacles are present in a signal path in free space outside the terminal. Similarly, the variable splitting may allow for focusing transmitting power where obstacles in free space are not present. In this regard, the variable splitting can be considered “active” variable splitting, enabling optimization of different transmit and receive beam profiles to improve link performance in real time.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. An optical communications terminal, comprising:
one or more variable couplers configured to variably split signals based on a splitting ratio; and
a control system operatively connected to the one or more variable couplers, the control system configured to drive the one or more variable couplers to variably split signals based on the splitting ratio, wherein the control system is configured to drive the one or more variable couplers based on one of i) measurements regarding a dither injected into a signal, or 2) measurements from one or more photodetectors operatively coupled to the one or more variable couplers.

2. The optical communications terminal of claim 1, further comprising the one or more photodetectors operatively connected to an output of the one or more variable couplers.

3. The optical communications terminal of claim 2, wherein:
the control system is operatively connected to the one or more photodetectors; and
the control system is configured to receive measurements from the one or more photodetectors.

4. The optical communications terminal of claim 1, wherein the splitting ratio is 50%/50%.

5. The optical communications terminal of claim 1, wherein the splitting ratio is 0%/100%.

6. The optical communications terminal of claim 1, wherein the splitting ratio is 100%/0%.

7. The optical communications terminal of claim 1, wherein in a receive direction, the one or more variable couplers include a first input and a second input.

8. The optical communications terminal of claim 7, wherein the first input and the second input are respectively connected to a first emitter and a second emitter.

9. The optical communications terminal of claim 7, wherein:
the one or more variable couplers include a first variable coupler, a second variable coupler, and a third variable coupler;
the first input is a first input of the first variable coupler operatively connected to an output of the second variable coupler; and
the second input is a second input of the first variable coupler operatively connected to an output of the third variable coupler.

10. The optical communications terminal of claim 1, wherein in a receive direction, the one or more variable couplers include a first output and a second output.

11. The optical communications terminal of claim 10, wherein the first output is connected to a photodetector of the one or more photodetectors.

12. The optical communications terminal of claim 10, wherein:
the one or more variable couplers include a first variable coupler and a second variable coupler; and
the second output is connected to one of the second variable coupler or an edge coupler.

13. The optical communications terminal of claim 1, wherein in a transmit direction, the one or more variable couplers include a first output and a second output.

14. The optical communications terminal of claim 13, wherein the first output and the second output are respectively connected to a first emitter and a second emitter.

15. The optical communications terminal of claim 13, wherein:
the one or more variable couplers include a first variable coupler, a second variable coupler, and a third variable coupler;
the first output is a first output of the first variable coupler operatively connected to an input of the second variable coupler; and
the second output is a second output of the first variable coupler operatively connected to an input of the third variable coupler.

16. A method of variably splitting a signal in an optical communications terminal, the method comprising:
receiving, at one or more inputs of a variable coupler of the optical communications terminal, one or more portions of a signal;
driving, by a control system of the optical communications terminal, the variable coupler to split the one or more portions of the signal based on a splitting ratio;
outputting, by a first output of the variable coupler, a first portion of the signal based on the splitting ratio; and
outputting, by a second output of the variable coupler, a second portion of the signal based on the splitting ratio.

17. The method of claim 16, wherein the splitting ratio is one of 50%/50%; 0%/100%; or 100%/0%.

18. The method of claim 16, wherein the first output of the variable coupler is directed towards a photodetector of the one or more photodetectors.

19. The method of claim 16, wherein the first output of the variable coupler is directed towards an emitter.

20. The method of claim 16, wherein the driving is based on one of i) measurements regarding a dither injected into a signal at a previous timestep, or 2) measurements from one or more photo detectors operatively coupled to the one or more variable couplers at the previous timestep.
